(19) United States
(12) Patent Application Publication
(10) Pub. No.: US 2021/0385827 A1
(43) Pub. Date: Dec. 9, 2021

(54) METHOD AND DEVICES FOR RESOURCE ALLOCATION IN A WIRELESS COMMUNICATION SYSTEM

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 17/043,772

(22) PCT Filed: Apr. 3, 2018
(86) PCT No.: PCT/CN2018/081750

§ 371 Date: Sep. 30, 2020

(51) Int. Cl. H04W 72/12; H04W 72/04; H04L 5/00

(52) U.S. Cl. CPC H04W 72/1263; H04L 5/0094; H04L 5/0039; H04W 72/0453

(57) ABSTRACT

Embodiments of the present disclosure relate to methods, devices, and computer readable medium for resource allocation. A method in a terminal device comprises: determining a granularity configuration and a distribution configuration for a mapping between an allocated virtual resource and a physical resource for a transmission from the terminal device, the granularity configuration indicating a resource granularity for the mapping, and the distribution configuration indicating the number of resource groups into which the allocated virtual resource is divided when being mapped to the physical resource; and determining the mapping between the allocated virtual resource and the physical resource based on the granularity configuration and the distribution configuration.

### FIELD

Non-limiting and example embodiments of the present disclosure generally relate to a technical field of wireless communication, and specifically to methods and devices for resource allocation.

### BACKGROUND

This section introduces aspects that may facilitate better understanding of the disclosure. Accordingly, the statements of this section are to be read in this light and are not to be understood as admissions about what is in the prior art or what is not in the prior art.

Currently a new fifth generation (5G) wireless communication technique is being studied in the third generation partnership project (3GPP). An access technology called New Radio (NR) is adopted in 5G communication systems.

In 3GPP, a study item on utilization of unlicensed spectrum in NR has been agreed. This study item has started from February 2018, focusing on techniques which allow the operators to augment their service offering by utilizing unlicensed spectrum. The unlicensed spectrum may be utilized in a Licensed Assisted Access (LAA) mode or a standalone mode.

### SUMMARY

Various embodiments of the present disclosure mainly aim at improving resource allocation for wireless communication.

In a first aspect of the disclosure, there is provided a method implemented at a terminal device for resource allocation. The method comprises: determining a granularity configuration and a distribution configuration for a mapping between an allocated virtual resource and a physical resource, and determining the mapping between the allocated virtual resource and the physical resource based on the granularity configuration and the distribution configuration. The granularity configuration indicates a resource granularity for the mapping, and the distribution configuration indicates the number of resource groups into which the allocated virtual resource is divided when being mapped to the physical resource.

In a second aspect of the disclosure, there is provided a method implemented at a network device for resource allocation. The method comprises: determining a mapping between an allocated virtual resource and a physical resource for a transmission from a terminal device based on a granularity configuration and a distribution configuration for the terminal device, and receiving a transmission from the terminal device in the physical resource. The granularity configuration indicates a resource granularity for the mapping, and the distribution configuration indicates the number of resource groups into which the allocated virtual resource is divided when being mapped to the physical resource.

In a third aspect of the disclosure, there is provided a terminal device. The terminal device comprises a processor and a memory. The memory contains instructions executable by said processor whereby said network device is operative to perform a method according to the first aspect of the disclosure.

In an fourth aspect of the disclosure, there is provided a network device. The network device comprises a processor and a memory. The memory contains instructions executable by said processor whereby said network device is operative to perform a method according to the second aspect of the disclosure.

In a fifth aspect of the disclosure, there is provided a computer readable medium with a computer program stored thereon which, when executed by at least one processor of a device, causes the device to carry out the method of the first aspect of the disclosure.

In a sixth aspect of the disclosure, there is provided a computer readable medium with a computer program stored thereon which, when executed by at least one processor of a device, causes the device to carry out the method of the second aspect of the disclosure.

Embodiments of the present disclosure may improve resource efficiency, and/or performance of wireless communication.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 illustrates an example wireless communication network in which embodiments of the present disclosure may be implemented;

FIGS. 2A-2B show an example for virtual resource to physical resource mapping;

FIG. 3 shows a flow chart of a method for resource allocation according to an embodiment of the present disclosure;

FIGS. 4-7 show examples for resource mapping according to embodiments of the present disclosure;

FIG. 8 shows a flow chart of another method for resource allocation according to an embodiment of the present disclosure; and

FIG. 9 illustrates a simplified block diagram of an apparatus that may be embodied as/comprised in a terminal device, or a network device according to embodiments of the present disclosure.

### DETAILED DESCRIPTION

Hereinafter, the principle and spirit of the present disclosure will be described with reference to illustrative embodiments. It should be understood that all these embodiments are given merely for one skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), LTE, NR, wireless local area network (WLAN) standards, such as the IEEE 802.11 standards, and/or any other appropriate wireless communication standard either currently known or to be developed in the future.

As used herein, the term “network device” refers to a network node in a wireless communication network to/from which a terminal device transmits/receives data and signaling. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communications. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “communication device”, “terminal”, “user equipment” and “UE” may be used interchangeably.

As yet another example, in an Internet of Things (TOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting its operational status or other functions associated with its operation.

As used herein, a downlink (DL) transmission refers to a transmission from a network device to UE, and an uplink (UL) transmission refers to a transmission in an opposite direction.

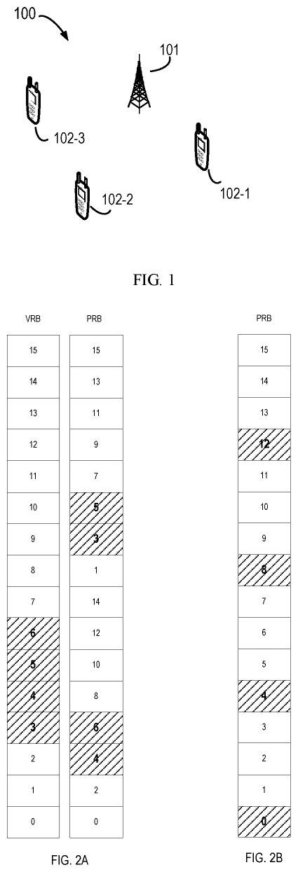

FIG. 1 illustrates an example wireless communication network 100 in which embodiments of the present disclosure may be implemented. As shown, the communication network 100 may include one or more network devices, for example a network device 101, which may be in a form of an eNB or gNB. It will be appreciated that the network device 101 could also be in a form of a Node B, BTS (Base Transceiver Station), and/or BSS (Base Station Subsystem), access point (AP) and the like. The network device 101 provides radio connectivity to a set of terminal devices, for example terminal devices 102-1, 102-2 and 102-3 which is collectively referred to as “terminal device(s) 102”. Though only three terminal devices are shown in FIG. 1 for simplicity, it should be appreciated that more or less terminal devices may be included in the communication network in practice.

Note that the network device 101 may communicate with the terminal devices 102 in a licensed or unlicensed frequency band. In some regions around the world, regulations have been specified for operating in an unlicensed frequency band. For example, pursuant to an European Telecommunications Standards Institute (ETSI) regulation on Occupied Channel Bandwidth (OCB), 99% power of UL transmission from a terminal device should occupy more than 80% of a system bandwidth of the unlicensed frequency band. In addition, power spectrum density (PSD) of a transmission should not exceed a specified threshold.

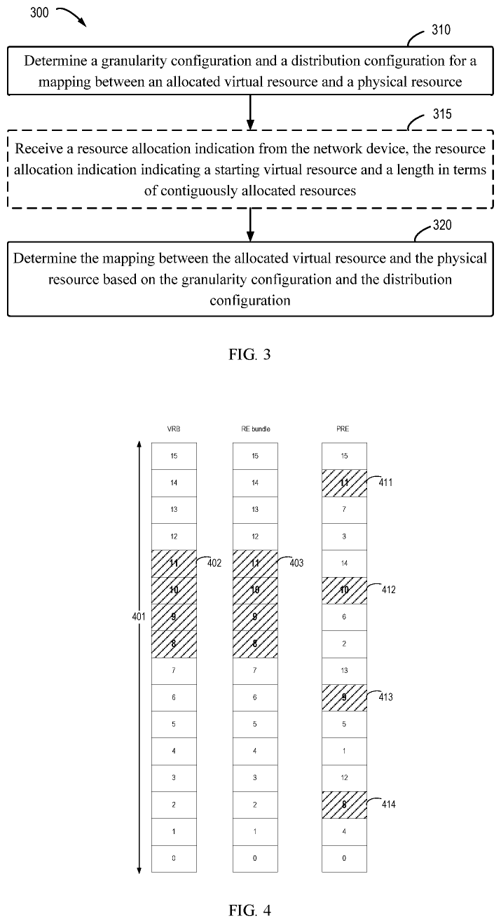

To meet regulations for an unlicensed frequency band, a resource interlacing method referred to as block interleaved frequency divisional multiplexing (B-IFDM) may be used. For illustration, an example for a resource allocation scheme currently used in NR and an example for an interleaved resource allocation used in LAA are shown in FIG. 2A and FIG. 2B respectively for comparison.

In the example shown in FIG. 2A, 4 virtual resource blocks (VRBs) indexed 3 to 6 are allocated to a terminal device, for example one terminal device 102 shown in FIG. 1. Then an interleaved VRB to physical resource block (PRB) mapping is adopted, for achieving frequency diversity in a NR Physical Uplink Share Channel (PUSCH) transmission, for example. As shown in FIG. 2A, during the VRB to PRB mapping, 4 continuous VRBs are divided into 2 distributed groups 210 and 220. The first group 210 includes PRBs indexed 4 and 6, while the second group 220 includes PRBs indexed 3 and 5. Note that whether to enable the interleaved VRB to PRB mapping may be configured by higher layer.

In the example shown in FIG. 2B, an interleaved resource allocation scheme is used where the system bandwidth is divided into several interlaced groups, and each group consists of a plurality of PRBs spreading across the system bandwidth. A terminal device is allocated one of the interlaced groups. In particular, in the example shown in FIG. 2B, a terminal device (for example one terminal device 102 shown in FIG. 1) is allocated a group including 4 PRBs indexed 0, 4, 8 and 12, which are distributed across the system bandwidth. Compared with the example shown in FIG. 2A, a more dispersed resource is allocated to the terminal device. Therefore, the resource allocation solution shown in FIG. 2B may be used in (e)LAA PUSCH to make a transmission compliant with an OCB regulation for an unlicensed frequency band.

It should be appreciated that the number of VRBs and the number of distributed groups shown in FIGS. 2A and 2B are just for illustration purpose, which means that same principle is applicable to resource allocations with a smaller or a larger bandwidth. As an example, spacing between adjacent distributed groups in the interleaved resource allocation scheme as shown in FIG. 2B may be 10 RBs for a system with 20 MHz bandwidth (including, for example, 100 RBs) or 10 MHz bandwidth (including, for example, 50 RBs).

As shown in FIG. 2B, the interleaved (also referred to as interlaced) resource allocation distributes the allocated resources for a transmission uniformly across the system bandwidth, thereby meeting OCB regulations for an unlicensed frequency band.

Since a NR system may need to support a standalone operation mode in an unlicensed band, uplink control transmission in the unlicensed band should also be supported. For instance, a Physical Uplink Control Channel (PUCCH) transmission with one of the formats 0 to 4 shown in Table 1 may be performed in the unlicensed band.

TABLE 1
PUCCH format

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

Currently, a PUCCH transmission with format 0, 1 or 4 occupies 1 RB, and a PUCCH transmission with format 2 or 3 may occupy multiple RBs, for example 16 RBs at maximum. However, such a transmission format cannot satisfy the OCB regulation for an unlicensed frequency band. To solve the problem, it is proposed in a 3GPP document R1-162939 that for PUCCH which occupies one PRB (e.g., PUCCH format 1/1a/1a, 2/2a/2b, 3, and 5), the PUCCH resources can be repeated every M (e.g., 5 or 10) RBs. Several alternatives for spreading the PUCCH resources have been discussed in the document. For example, the PUCCH resources can be block-spread in frequency domain, or, a distributed mapping of PUCCH resources in combination with a self-spreading of PUCCH resources may be used. In addition, to increase the multiplexing capacity, REs of a single PUCCH RB may be partially spread into M RBs.

Inventors of the present disclosure have realized that licensed or unlicensed frequency bands available for a wireless communication system (e.g., a NR system) may have different characteristics in terms of total bandwidth, total number of RBs, regulation condition, frequency spacing and/or frequency of the band. For instance, different numerologies (including different subcarrier spacing (SCS) and/or different symbol lengths) may be adopted in different frequency bands, and/or in different time intervals for a same frequency band. Conventional resource allocation solutions are not flexible enough to support wireless communication in frequency bands with variable characteristics.

A numerology dependent interlacing scheme is proposed in a 3GPP document R1-1802865, where an eLAA interlace waveform can be applied to resource allocation directly for a SCS of 15 KHz, while for a SCS of 30 KHz, 5 interlaces can be defined where each interlace consists of 10 RBs uniformly separated 5 RBs apart. In addition, it is proposed that with a SCS of 60 KHz, a sub-RB based interlace structure can be introduced. One example is to define 5 interlaces where each interlace consists of 10 sub-RBs, and where each sub-RB consists of 6 REs and they are uniformly separated 5 sub-RBs apart. This scheme only provides a specific design for some particular settings of numerology, but fails to provide a flexible way for adapting to various characteristics of potential operating frequency bands.

Furthermore, some corner case of resource allocation has not been considered. For example, how to design an interlacing pattern when the allocated number of RBs (e.g., for PUCCH) is larger than the number of interlaces is still an open problem.

To improve resource allocation, methods, devices and computer readable medium have been proposed in the present disclosure. In some embodiments, an improved interleaved VRB to PRB mapping is proposed to provide a unified and configurable method for solving frequency resource allocation (e.g., for PUSCH and/or PUCCH) in an unlicensed frequency band. However, it should be appreciated that embodiments of the present disclosure are not limited to being implemented in an unlicensed frequency band or a NR system, but could be more widely applied to any frequency band or wireless communication system where similar problem exists.

In some embodiments, a resource allocation for a terminal device (e.g., terminal device 102 in FIG. 1) may be configured based on at least one of: the number RBs in a system bandwidth, regulation condition for a frequency band, SCS and frequency of the band, etc.

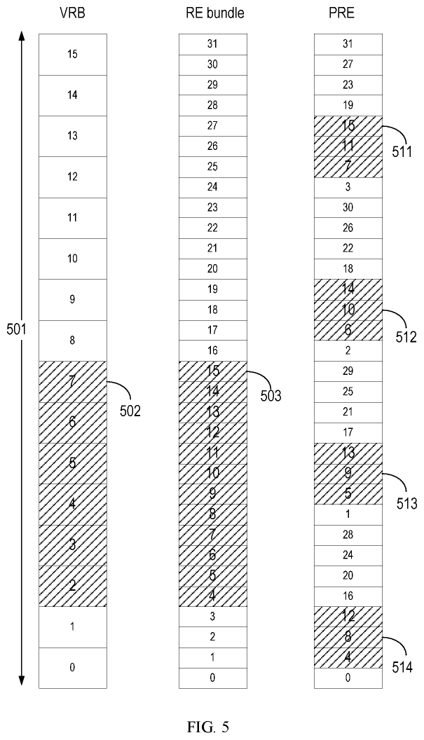

Reference is now made to FIG. 3, which shows a flow chart of an example method 300 for resource allocation according to an embodiment of the present disclosure. The method 300 may be implemented by, for example, a terminal device 102 shown in FIG. 1. For ease of discussion, the method 300 will be described below with reference to the terminal device 102 and the communication network 100 illustrated in FIG. 1. However, embodiments of the present disclosure are not limited thereto.

In the method 300, configuration parameters including granularity configuration and a distribution configuration are introduced for determining a resource allocation. As shown in FIG. 3, at block 310, the terminal device 102 determines a granularity configuration and a distribution configuration for mapping an allocated virtual resource to a physical resource for its transmission. The granularity configuration indicates a resource granularity for the mapping, and the distribution configuration indicates the number of resource groups into which the allocated virtual resource is divided when being mapped to the physical resource.

In some embodiments, the terminal device 102 may determine the granularity configuration and the distribution configuration for the mapping by receiving one or both of the granularity configuration and the distribution configuration from a network device, for example, network device 101 in FIG. 1. For illustration rather than limitation, at least one of the granularity configuration and the distribution configuration may be transmitted from the network device 101 to the terminal device 102 via a higher layer signaling, for example a radio resource control (RRC) signaling. It should be appreciated that in some embodiments, other signaling may be used for carrying the granularity configuration and/or the distribution configuration. For simplicity, the granularity configuration and the distribution configuration may be denoted using parameter P and F respectively hereafter.

Alternatively or in addition, at block 310, the terminal device 102 may determine at least one of the granularity configuration P and the distribution configuration F based on a predefined table associating the at least one of P and F with at least one of a SCS, a system bandwidth and the total number of resource blocks in the system bandwidth. As an example, both of the granularity configuration ° and the distribution configuration F may be determined by looking up the predefined table, for example Table 2 below, based on configurations of SCS and the system bandwidth.

In an example embodiment, if the SCS is 30 KHz, system bandwidth is 60 MHz, and there are 162 RBs in the system bandwidth, the terminal device 102 may determine the value for ρ and F to be 1 and 9 respectively based on Table 2.

TABLE 2
Configuration for resource allocation

| SCS | System bandwidth | Number of RBs | ρ | F |
|---|---|---|---|---|
| 15 KHz | 10 MHz | 100 | 1 | 10 |
| 15 KHz | 20 MHz | 100 | 1 | 10 |
| 15 KHz | 40 MHz | 216 | 1 | 12 |
| 30 KHz | 20 MHz | 50 | 1 | 10 |
| 30 KHz | 40 MHz | 100 | 1 | 10 |
| 30 KHz | 60 MHz | 162 | 1 | 9 |
| 30 KHz | 80 MHz | 216 | 1 | 12 |
| 30 KHz | 100 MHz | 272 | 1 | 16 |
| 60 KHz | 20 MHz | 24 | 1, ½ | 12, 6 |
| 60 KHz | 40 MHz | 50 | 1, ½ | 10, 5 |
| 60 KHz | 60 MHz | 75, 72 | 1 | 15, 12 |
| 60 KHz | 80 MHz | 100 | 1 | 10 |
| 60 KHz | 100 MHz | 135 | 1 | 9 |

In another embodiment, if the SCS is 60 KHz and the system bandwidth is 20 MHz which includes 24 RBs, the terminal device 102 may determine the value for (ρ, F) to be (1, 12) or (½, 6) based on the Table 2. In a further embodiment, the terminal device 102 may decide whether to use the values (1, 12) or (½, 6) for (ρ, F) further based on a signaling from the network device 101. Likewise, if the SCS is 60 KHz and the system bandwidth is 40 MHz which includes 50 RBs, the terminal device 102 may determine the value for (ρ, F) to be (1, 10) or (½, 5) based on the Table 2.

Alternatively, in another embodiment, a hybrid determination scheme may be used. For instance, one of the granularity configuration ρ and the distribution configuration F may be determined based on the predefined table (for example Table 2), while the other one may be determined implicitly or received via signaling from the network device 101, for example RRC signaling.

At block 320, the terminal device 102 determines the mapping between the allocated virtual resource and the physical resource for its transmission based on the determined granularity configuration and the distribution configuration.

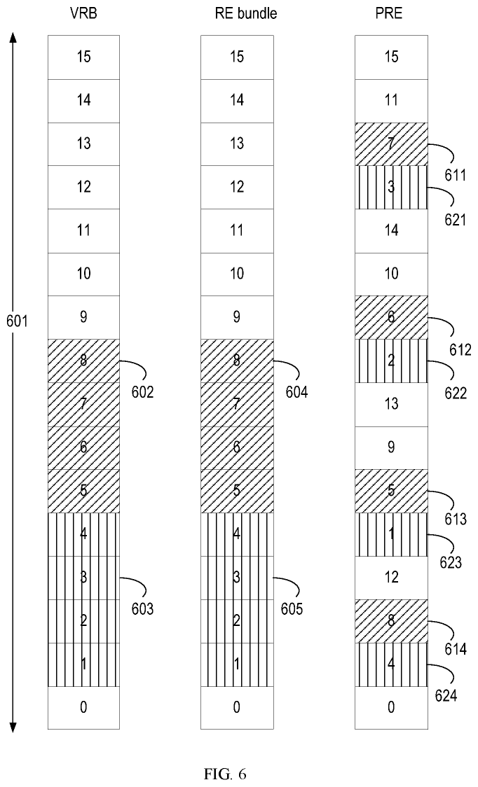

Just for illustration purpose, some examples for determining the mapping between an allocated virtual resource and a physical resource based on the determined granularity configuration and the distribution configuration are shown in FIGS. 4 and 5. It should be appreciated that though some specific values/settings are used in the examples, they are presented just for schematic illustration rather than limitation. That is to say, same principle applies to other scenarios and system configurations.

In the example shown in FIG. 4, a system bandwidth 401 with 16 RBs and a resource allocation 402 with 4 VRBs for a transmission from the terminal device 102 are assumed for simplicity. Furthermore, in this example, assuming ρ is determined to be 1, and the distribution configuration F is determined to be 4 at block 310 by the terminal device 102, based on, for example, signaling, or a table, or a combination thereof. In some embodiments, at block 320, the terminal device 102 may determine a resource granularity for the virtual resource to physical resource mapping based on the granularity configuration. The resource granularity may also be referred to as a resource element (RE) bundle hereafter in the disclosure. In some embodiments, the resource granularity may be determined as a RE bundle comprising a plurality of subcarriers based on the granularity configuration. For example, the RE bundle may comprise L subcarriers, where L=└ρN_{sc}^{RB}┘, ρ denotes a value of the determined granularity configuration, N_{sc}^{RB} denotes the number of subcarriers in a RB, and └ ┘ denotes a floor operation. In the example of FIG. 4, with ρ=1, L is determined to be 12 subcarriers, i.e., a RE bundle equals to 1 RB in this case, and 4 RE bundles 403 including 4 RBs are to be mapped to the physical resource, as shown in FIG. 4.

The 4 RE bundles 403 may be distributed in a wide band during the mapping to the physical resource, for example to meet an OCB regulation for an unlicensed band. In some embodiments, at block 320, the terminal device 102 may further determine the number of resource groups into which the allocated virtual resource is divided. As an example, the number of resource groups may be determined based on both of the determined distribution configuration F and granularity configuration ρ. In FIG. 4, the number of resource groups R may be determined to be R=F/ρ=4, with 1 RE bundle in each group. As shown in FIG. 4, 4 groups 411-414 are separated apart. In this way, OCB regulation for an unlicensed band may be met.

In a further embodiment of the disclosure, at block 320, the terminal device 102 may determine spacing between adjacent resource groups based on total number of resource blocks in a system bandwidth and the determined distribution configuration. For example rather than limitation, the spacing may be determined to be N_{spac} RE bundles, where N_{spac}=N/F, N denotes the total number of resource blocks in a system bandwidth and F denotes a value of the determined distribution configuration. In the example of FIG. 4, N=16, F=4, the spacing between adjacent resource groups is determined to be N_{spac}=4 RE bundles, and therefore adjacent groups (e.g., groups 411 and 412) are separated 4 RE bundles apart, as shown in FIG. 4. It should be appreciated that embodiments are not limited to determining the spacing in such a specific way. For example, in another embodiment, the spacing N_{spac} may be determined to be N_{spac}=α.N/F, where α may be a scaling factor for the terminal device 102.

Another example is shown in FIG. 5 where a total bandwidth 501 of 16 RBs and a resource allocation 502 with 6 VRBs for a transmission from the terminal device 102 are assumed. Furthermore, in this example, assuming that ρ is determined to be ½, and the distribution configuration F is determined to be 2 at block 310 by the terminal device 102, based on, for example, signaling, or table, or a combination thereof. Then, at block 320, the terminal device 102 may determine the resource granularity (i.e., RE bundle) for the virtual resource to physical resource mapping to be L subcarriers, where L=└ρN_{sc}^{RB}┘=6. That is, one RE bundle corresponds to half a RB in this example. Therefore, the allocated 6 RBs 502 corresponds to 12 RE bundles 503, as shown in FIG. 5.

In some embodiments, at block 320, the terminal device 102 may further determine the number of resource groups into which the allocated virtual resource is divided. In the example shown in FIG. 5, the number of resource groups may be determined to be R=F/ρ=4. As shown in FIG. 5, the 4 groups 511-514 are separated apart, with 3 RE bundles in each group.

Similar to the example in FIG. 4, the terminal device 102 may further determine spacing between adjacent resource groups as N_{spac} RE bundles, where N_{spac}=N/F. Since N=16, and F=2 in the example of FIG. 5, the spacing between adjacent resource groups is determined to be N_{spac}=8 RE bundles.

It should be appreciated that though specific values/settings for the system bandwidth, the number of allocated VRBs, the granularity configuration and the distribution configuration are adopted in FIGS. 4 and 5, they are presented as examples only, and embodiments are not limited to the specific values/settings. Instead, method 300 provides a flexible resource allocation scheme which is adaptive to various system configurations and scenarios.

In practice, the system bandwidth and correspondingly the number of RBs in the system bandwidth (denoted as N for simplicity) may be configurable, and hence the proposed configurable interlaced mapping scheme benefitting flexibility of a wireless communication system (e.g., a NR system) is a better choice for forward compatibility.

In addition, regulations for an unlicensed band may be region specific, which means that a regulation, such as the OCB regulation specified by ETSI, may not be applied in some regions, and in such a case, it may be unnecessary to adopt a distributed resource mapping in these regions. Taking such regulation condition into consideration, in some embodiments of the disclosure, it is proposed to use a unified and configurable method which supports a fallback mode for resource allocation, e.g., same resource allocation as that used in a licensed band may be applied to regions without OCB regulations. As an example, at block 310 of method 300 described above, the terminal device 102 may determine the granularity configuration as ρ=F (e.g., based on signaling or predefined rule), to use a fallback mode for resource allocation. In this case, the allocated VRBs are divided into R=F/ρ=1 group, which means that resources are not distributed.

As already discussed above, in some embodiments, values for parameters (such as the granularity configuration ρ and the distribution configuration F) may be determined based on system bandwidth, number of RBs in the system bandwidth, regulation condition, subcarrier spacing, and/or band frequency, etc., for example based on a predefined table like Table 2.

Alternatively or in addition, in some embodiments, the granularity configuration (e.g., ρ) may be determined by taking a demodulation reference signal (DMRS) mode into consideration. For instance, a value for ρ may be determined such that there is a complete DMRS group in each distributed resource group. As an example, ρ may be determined to be ⅓ or ¼ depending on the DMRS mode to be used in the transmission.

In some embodiment, the terminal device 102 may choose a value for the granularity configuration ρ from a predefined set of granularity values. For illustration rather than limitation, the predefined set of granularity values may include a value of 1 and a positive value smaller than 1. For example, the predefined set of granularity values may include 1, ¼, ⅓ and ½. The fractional number smaller than 1 (e.g., ½. ⅓, ¼) enables to improve frequency spectrum efficiency and utilization of energy of the terminal device 102.

In another embodiment, the predefined set of granularity values may include a value of F which is a value for the distribution configuration. That is, ρ may be set to be equal to F in some embodiments, to provide a fallback mode for resource allocation.

Note that in some embodiments, the terminal device 102 may directly receive a value for ρ and/or F from the network device 101, and the received value are chosen by the network device 101 from the predefined set of granularity values.

Now referring back to FIG. 3. In some embodiments, at block 320 in FIG. 3, the terminal device 102 may determine the virtual resource to physical resource mapping based on additional factors/parameters. For instance, in some embodiments, at block 315, the terminal device 102 may receive a resource allocation indication from the network device 101. The resource allocation indication indicates a starting virtual resource and a length in terms of contiguously allocated resources. In the present disclosure, the indicated starting virtual resource and length may be denoted as blockₛₜₐᵣₜ and L_{block} respectively for simplicity. Then at block 320, the terminal device 102 may determine the resource mapping further based on blockₛₜₐᵣₜ and L_{block} indicated by the received resource allocation indication. For illustration rather than limitation, the terminal device 102 may receive the resource allocation indication including the starting virtual resource blockₛₜₐᵣₜ and length L_{block} via a dynamic physical layer downlink control signal from network device 101. In some embodiments, the physical downlink control signaling may include a downlink control indication (DCI). As an example, the starting resource blockₛₜₐᵣₜ and the length L_{block} may be indicated via an information field of Resource Indication Value (RIV) in the DCI.

In some embodiments, both blockₛₜₐᵣₜ and L_{block} are indicated in a unit of a RB. In a further embodiment, the starting virtual resource blockₛₜₐᵣₜ may be a multiple of F, i.e., blockₛₜₐᵣₜ=m.F, where m is a positive integer. However, in order to save signaling overhead, in some embodiments, the network device 101 may only indicate the value of m rather than m.F to the terminal device 102. Correspondingly, at block 320 in FIG. 3, the terminal device 102 may determine a starting virtual resource block RBₛₜₐᵣₜ by multiplying the received value of blockₛₜₐᵣₜ with F, i.e., RBₛₜₐᵣₜ=F·blockₛₜₐᵣₜ. It should be appreciated that embodiments are not limited to such a specific way for determining the starting VRB, and in some embodiments, the terminal device 102 may determine the starting virtual resource block based on the indicated starting virtual resource blockₛₜₐᵣₜ and a value of the distribution configuration F in a different way. For example, the starting virtual resource block RBₛₜₐᵣₜ may be determined by RBₛₜₐᵣₜ=F·blockₛₜₐᵣₜ+β, where β is a resource offset which may be a constant or configured for the terminal device 102.

Likewise, in some embodiments, L_{block} may also be indicated to the terminal device in a compact way. For example, if L_{block}=n.F, then the network device 101 may only indicate the value of n to the terminal. In such embodiments, at block 320, the terminal device determines the number of contiguously allocated resource blocks based on the indicated length and a value of the distribution configuration F. For example, the number of contiguously allocated resource blocks L_{RBs} may be determined, for example, by one of: L_{RBs}=F·L_{block}, L_{RBs}=F·L_{block}+λ and L_{RBs}=λ·F·L_{block} where F denotes the value of the distribution configuration, L_{block} denotes the received value for the length in terms of contiguously allocated resources, and 2 is an adjusting factor which may be constant or configured for the terminal device 102.

Examples for determining the resource mapping based on the starting virtual resource and length (i.e., blockₛₜₐᵣₜ and L_{block}) may be found in FIGS. 4 and 5. In the example of FIG. 4, F=4 blockₛₜₐᵣₜ=2 and L_{block}=1. As a result, the terminal device 102 may determine the starting RB to be RBₛₜₐᵣₜ=F·blockₛₜₐᵣₜ=8, and the number of RBs allocated to be L_{RBs}=F·L_{block}=4. That is, 4 VRBs 402 starting from index 8 are allocated to the terminal device for mapping to physical resources. Likewise, in FIG. 5, F=4, blockₛₜₐᵣₜ=1, and L_{block}=3, and the terminal device 102 may determine the starting RB to be RBₛₜₐᵣₜ=F·blockₛₜₐᵣₜ=4, and the number of RBs allocated to be L_{RBs}=F·L_{block}=6. That is, 6 VRBs 502 starting from index 4 are allocated to the terminal device for mapping to physical resources.

Note that embodiments of the present disclosure may be used for resource allocation for data and/or control transmission. Control signaling such as PUCCH has a relatively small payload, and therefore may require only a small number of RBs. For example, 1 RB may be used for PUCCH transmissions with format 0, 1 and 4, while multiple (e.g., 16 at the maximum) RBs may be used for PUCCH transmissions with format 2 or 3. Furthermore, the number of RBs for PUCCH format 2 and format 3 may be configured via high layer signaling PUCCH-F2-number-of-PRBs and PUCCH-F3-number-of-PRBs respectively.

In addition, the starting RB for PUCCH may be indicated by a high layer signaling PUCCH-starting-PRB. However, it should be appreciated that the specific signaling are just presented as examples, and embodiments of the present disclosure are not limited to any specific signaling for carrying the resource allocation configurations to the terminal device.

Considering the above characteristics for PUCCH transmission, it is proposed same method for virtual resource to physical resource mapping described above may be applied to PUCCH, however, in some embodiments, the determination operation for the length of the allocated resource may be further improved. For example, the indicated starting RB number and the length of the allocated resource may not be a multiple of F.

For example rather than limitation, for PUCCH transmission, if the resource allocation indication received by the terminal device 102 at block 315 (e.g., via a high layer signaling PUCCH-Fx-number-of-PRBs) indicates a value L_{block} for the length in terms of contiguously allocated resources, the terminal device 102 may determine the length in terms of contiguously allocated resources based on the indicated L_{block} and F. For instance, if the indicated length L_{block} is less than F, the length L_{RBs} in terms of contiguously allocated resources may be determined to be F; and if the indicated length L_{block} is no less than F, the length L_{RBs} in terms of contiguously allocated resources may be determined to be the indicated length L_{block}, in other words,

if L_{block}<F,L_{RBs}=F;

otherwise L_{RBs}=L_{block}.

An example for resource allocation is shown in FIG. 6. In this example, two terminal devices (e.g., terminal devices 102-1 and 102-2 in FIG. 1) are multiplexed in the system bandwidth 601, and resource allocation configuration parameters for the two terminal devices are shown in Table 3.

TABLE 3
Resource allocation configuration for terminal devices

| Terminal device/configuration | N | ρ | F | blockₛₜₐᵣₜ | L_{block} |
|---|---|---|---|---|---|
| 102-1 | 16 | 1 | 4 | 1 | F |
| 102-2 | 16 | 1 | 4 | 5 | F |

In this example, for both terminal devices, the configured L_{block}=F, and the length in terms of contiguously allocated resources may be determined to be L_{RBs}=L_{block}=4. As a result, as shown in FIG. 6, both terminal devices are allocated 4 VRBs. Since blockₛₜₐᵣₜ=1 is configured for terminal device 102-1, the allocated VRBs 602 for terminal device 102-1 starts from RB with an index of 1. Likewise, blockₛₜₐᵣₜ=5 for terminal device 102-2, and as a result, the allocated VRBs 603 for terminal device 102-2 starts from RB with an index of 5, as shown in FIG. 6. In this example, ρ=1 is configured for both terminal devices, and the resource granularity, i.e., RE bundle, is determined to be 1 RB for both terminal devices. As shown in FIG. 6, the allocated VRBs 602 and 603 correspond to RE bundles 604 and 605 respectively. In addition, since ρ=1 and F=4 are configured for both terminal devices, each of the allocated VRBs 602 and 603 may be divided into R=F/ρ=4 distributed groups, i.e., groups 611-614 for terminal device 102-1, and groups 621-624 for terminal devices 102-2.

Another example for resource allocation is shown in FIG. 7. In this example, two terminal devices (e.g., terminal devices 102-1 and 102-2 in FIG. 1) are multiplexed in the system bandwidth 701, and resource allocation configuration parameters for the two terminal devices are shown in Table 4.

TABLE 4
Resource allocation configuration for terminal devices

| Terminal device/configuration | N | ρ | F | blockₛₜₐᵣₜ | L_{block} |
|---|---|---|---|---|---|
| 102-1 | 16 | 1 | 4 | 1 | 6 |
| 102-2 | 16 | 1 | 4 | 9 | 5 |

In this example, L_{block}=6, blockₛₜₐᵣₜ=1 are configured for terminal device 102-1, and L_{block}=5, blockₛₜₐᵣₜ=9 are configured for terminal device 102-2, and as a result, 6 VRBs 702 starting from VRB #1, and 5 VRBs 703 starting from VRB #9 are allocated for the two terminal devices respectively, as shown in FIG. 7. In this example, ρ=1 is configured for both terminal devices, and the resource granularity (i.e., RE bundle) is determined to be 1 RB for both terminal devices. As shown in FIG. 7, the allocated VRBs 702 and 703 correspond to RE bundles 704 and 705 respectively. In addition, since ρ=1 and F=4 are configured for both terminal devices, each of the allocated VRBs 702 and 703 are divided into R=F/ρ=4 distributed groups, i.e., groups 711-714 for terminal device 102-1, and groups 721-724 for terminal devices 102-2.

Alternatively, in another embodiment, the terminal device 102 may determine the length in terms of contiguously allocated resources to be L_{RBs}=m·F, where m is the smallest integer satisfying m·F>=L_{block}. For example, if the configured L_{block}=5, F=4, than the number of contiguously allocated RBs for PUCCH may be determined to be L_{RBs}=2·F=8 RBs. In this way, the allocated resource for PUCCH is distributed in the system bandwidth, and thereby frequency diversity may be improved, and/or OCB regulation for an unlicensed frequency band may be satisfied.

Among other advantages, the proposed resource allocation solution can be easily integrated with current resource allocation scheme. For example, current LTE system may be easily upgraded to adopt the proposed solution. As an example rather than limitation, to improve resource efficiency and/or adapt to regulations for an unlicensed frequency band, a new interleaved virtual resource element (VRE) to physical resource element (PRE) mapping may be defined according to an embodiment of the present disclosure as below.

Firstly, a RE bundle i may be defined as resource elements {iL, iL+1, . . . , iL+L−1} where L=└ρ·N_{sc}^{RB}┘ is the resource element bundle size, and ρ is granularity configuration (which may also be referred to as block density) provided by the higher-layer parameter.

Secondly, a VRE bundle j may be mapped to PRE bundle f(j), where:

f(j)=rC+c

j=cR+r

r=0,1, . . . ,R−1

c=0,1, . . . ,C−1

R=F/ρ

C=ΠN_{sc}^{RB}N_{BWP,i}^{size}/(LR)┐. (1)

In above equations, N_{BWP,i}^{size} represents the size of the bandwidth part in which PUSCH or PUCCH is transmitted, and F is distribution configuration (which may also be referred to as a scaling factor) provided by the higher-layer parameter.

In addition, for an uplink type 2 resource allocation field consists of a RIV corresponding to a starting virtual resource block (RBₛₜₐᵣₜ) and a length in terms of contiguously allocated resource blocks L_{RBs}. The resource indication value transmitted by the network device 101 and received by the terminal device 102 may be defined as below:

if (L_{block}−1)≤└N_{BWP}^{block}/2┘, then

RIV′=N_{BWP}^{block}(L_{block}−1)+blockₛₜₐᵣₜ (2)

Else,

RIV′=N_{BWP}^{block}(N_{BWP}^{block}−L_{block}+1)+(N_{BWP}^{block}−1−blockₛₜₐᵣₜ), (3)

where L_{block}≥1 and is no larger than N_{BWP}^{block}−blockₛₜₐᵣₜ. In addition, N_{BWP}^{block}=N_{BWP}^{size}/F, RBₛₜₐᵣₜ=F·blockₛₜₐᵣₜ, and L_{RBs}=F·L_{block}, where F is a scaling factor provided by the higher-layer parameter.

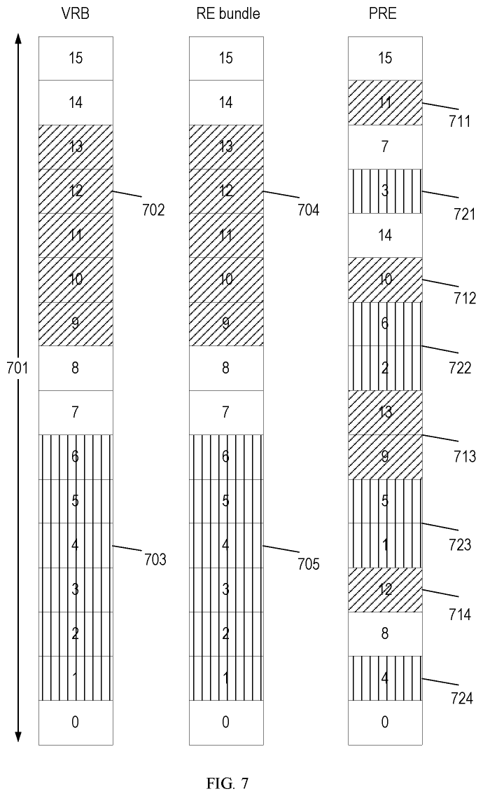

Reference is now made to FIG. 8, which shows a flow chart of another method 800 for resource allocation according to an embodiment of the present disclosure. The method 800 may be implemented by, for example, network device 101 shown in FIG. 1. For ease of discussion, the method 800 will be described below with reference to network device 101 and the communication network 100 illustrated in FIG. 1. However, embodiments of the present disclosure are not limited thereto.

As shown in FIG. 8, at block 810, network device 101 determines a mapping between an allocated virtual resource and a physical resource based on a granularity configuration and a distribution configuration for a terminal device, for example terminal device 102 in FIG. 1. The granularity configuration indicates a resource granularity (which may be referred to as a RE bundle) for the mapping, and the distribution configuration indicates the number of resource groups into which the allocated virtual resource is divided when being mapped to the physical resource. Descriptions with respect to the granularity configuration ρ and the distribution configuration F, provided with reference to method 300 and FIGS. 3-7 also apply here, and therefore, details will not be repeated.

At block 820, the network device 101 receives a transmission from the terminal device 102 in the physical resource.

Optionally, in some embodiments, at block 805, the network device 101 may transmit at least one of the granularity configuration and the distribution configuration to the terminal device 102, in order to achieve a common understanding between the network device 101 and the terminal device 102 on the resource mapping. As an example rather than limitation, the at least one of the granularity configuration and the distribution configuration may be transmitted to the terminal device 102 via a higher layer signaling, for example a RRC signaling.

Alternatively or in addition, in some embodiments, at block 803, the network device 101 may determine at least one of the granularity configuration ρ and the distribution configuration F based on a predefined table associating the at least one of ρ and F with at least one of a SCS, a system bandwidth and the total number of resource blocks in the system bandwidth. Table 2 may be considered as an example of the predefined table. In such a case, both the network device 101 and the terminal device 102 may determine the configuration parameters of ρ and/or F based on a known table, and therefore signaling for transmitting ρ and/or F may be avoided. It should be appreciated that in some embodiments, a hybrid method may be used for the determination of the granularity configuration and the distribution configuration. For example, one of ρ and F may be determined based on a predefined table by both the network device 101 and terminal device 102, while the other may be derived implicitly. Or, one of ρ and F may be signaled by the network device 101 to the terminal device 102, while the other is derived by both sides implicitly.

In some embodiments, at block 810, the network device 101 may determine the mapping based on the granularity configuration and the distribution configuration in the same way as that described for terminal device 102. Therefore, descriptions about determining the mapping provided with reference to method 300 and FIGS. 3-7 also apply here, and details will not be repeated.

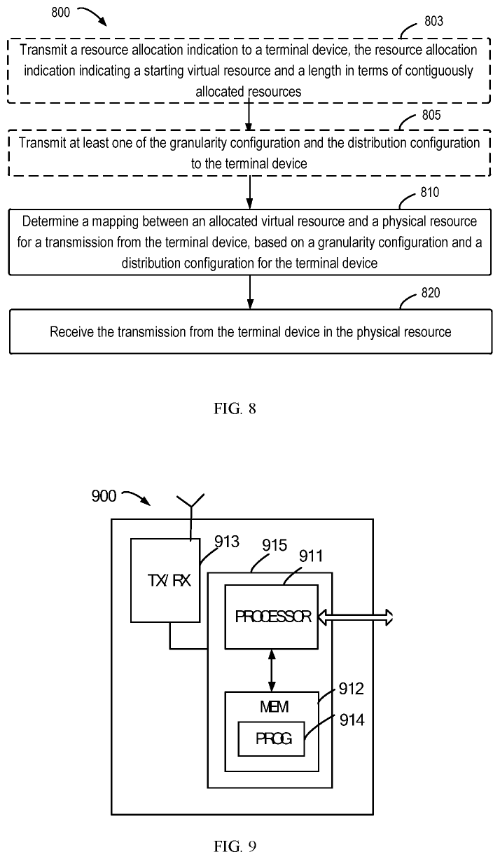

FIG. 9 illustrates a simplified block diagram of an apparatus 900 that may be embodied as/comprised in a terminal device (for example, the terminal device 102 shown in FIG. 1) or a network device (for example, the network device 101 shown in FIG. 1).

The apparatus 900 comprises at least one processor 911, such as a data processor (DP) and at least one memory (MEM) 912 coupled to the processor 911. The apparatus 900 may further include a transmitter TX and receiver RX 913 coupled to the processor 911, which may be operable to communicatively connect to other apparatuses. The MEM 912 stores a program or computer program code 914. The at least one memory 912 and the computer program code 914 are configured to, with the at least one processor 911, cause the apparatus 900 at least to perform in accordance with embodiments of the present disclosure, for example method 300 or 800.

A combination of the at least one processor 911 and the at least one MEM 912 may form processing means 915 configured to implement various embodiments of the present disclosure.

Various embodiments of the present disclosure may be implemented by computer program executable by the processor 911, software, firmware, hardware or in a combination thereof.

The MEM 912 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processor 911 may be of any type suitable to the local technical environment, and may include one or more of general purpose computers, special purpose computers, microprocessors, digital signal processors (DSPs) and processors based on multicore processor architecture, as non-limiting examples.

In addition, the present disclosure may also provide a carrier containing the computer program as mentioned above. The carrier includes a computer readable storage medium and a transmission medium. The computer readable storage medium may include, for example, an optical compact disk or an electronic memory device like a RAM (random access memory), a ROM (read only memory), Flash memory, magnetic tape, CD-ROM, DVD, Blue-ray disc and the like. The transmission medium may include, for example, electrical, optical, radio, acoustical or other form of propagated signals, such as carrier waves, infrared signals, and the like.

The techniques described herein may be implemented by various means so that an apparatus implementing one or more functions of a corresponding apparatus described with an embodiment comprises not only prior art means, but also means for implementing the one or more functions of the corresponding apparatus and it may comprise separate means for each separate function, or means that may be configured to perform two or more functions. For example, these techniques may be implemented in hardware (e.g., circuit or a processor), firmware, software, or combinations thereof. For a firmware or software, implementation may be made through modules (e.g., procedures, functions, and so on) that perform the functions described herein.

Some example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, may be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments may also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept may be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

Some abbreviations used in the present disclosure and their corresponding expressions are list below:

3GPP 3rd generation partnership project

### LTE Long Term Evolution

### NR New Radio

(e)LAA (enhanced) LTE Licensed Assisted Access

### PUCCH Physical Uplink Control Channel

### PUSCH Physical Uplink Shared Channel

### RB Resource Block

### RE Resource Element

DCI Downlink control indicator

### RIV Resource Indication Value

### OCB Occupied Channel Bandwidth

### ETSI European Telecommunications Standards Institute

### SCS Sub-Carrier Spacing

1. A method for resource allocation, comprising:
determining a granularity configuration and a distribution configuration for a mapping between an allocated virtual resource and a physical resource, the granularity configuration indicating a resource granularity for the mapping, and the distribution configuration indicating the number of resource groups into which the allocated virtual resource is divided when being mapped to the physical resource; and
determining the mapping between the allocated virtual resource and the physical resource based on the granularity configuration and the distribution configuration.

2. The method of claim 1, wherein determining the granularity configuration and the distribution configuration comprising:
receiving at least one of the granularity configuration and the distribution configuration from a network device.

3. The method of claim 2, wherein receiving at least one of a granularity configuration and a distribution configuration comprises:
receiving the at least one of the granularity configuration and the distribution configuration via a radio resource control, RRC, signaling from the network device.

4. The method of claim 1, wherein determining the granularity configuration and the distribution configuration comprising:
determining at least one of the granularity configuration and the distribution configuration based on a predefined table associating the at least one of the granularity configuration and the distribution configuration with at least one of a subcarrier spacing, a system bandwidth and the total number of resource blocks in the system bandwidth.

5. The method of claim 1, wherein determining the mapping comprises:
determining the resource granularity for the mapping as a resource element bundle comprising a plurality of subcarriers, based on a value of the determined granularity configuration and the number of subcarriers in a resource block.

6. The method of claim 5, wherein the resource element bundle comprises L subcarriers, where L=└ρN_{sc}^{RB}┘, ρ denotes a value of the determined granularity configuration, N_{sc}^{RB} denotes the number of subcarriers in a resource block and └ ┘ denotes a floor operation.

7. The method of claim 1, wherein determining the mapping comprises:
determining the number of resource groups based on the determined granularity configuration and distribution configuration.

8. The method of claim 7, wherein determining the number of resource groups comprises:
determining the number of resource groups as R=F/ρ, where F denotes a value of the determined distribution configuration, and ρ denotes a value of the determined granularity configuration.

9. The method of claim 1, wherein a value for the granularity configuration is determined to be same as a value for the distribution configuration.

10. The method of claim 1, wherein determining the mapping comprises:
determining spacing between adjacent resource groups based on total number of resource blocks in a system bandwidth and the determined distribution configuration.

11. The method of claim 10, wherein the spacing between adjacent resource groups is determined as N_{spac}=N/F, where N denotes the total number of resource blocks in a system bandwidth and F denotes a value of the determined distribution configuration.

12. The method of claim 1, wherein the granularity configuration indicates a value selected from a predefined set including a positive number smaller than 1.

13. The method of claim 12, wherein the predefined set includes a value of ⅓ associated with a first demodulation reference signal mode, and a value of ¼ associated with a second demodulation reference signal mode.

14. The method of claim 1, wherein the granularity configuration is specific to a demodulation reference signal mode.

15. The method of claim 1, further comprising:
receiving a resource allocation indication from the network device, the resource allocation indication indicating a starting virtual resource and a length in terms of contiguously allocated resources.

16. The method of claim 15, wherein determining the mapping comprises:
determining a starting virtual resource block based on the indicated starting virtual resource and a value of the determined distribution configuration.

17. The method of claim 16, wherein the starting virtual resource block is determined as RBₛₜₐᵣₜ=F·blockₛₜₐᵣₜ, where F denotes the value of the determined distribution configuration, and blockₛₜₐᵣₜ denotes a value of a starting virtual resource indicated by the received resource allocation indication.

18. The method of claim 15, wherein determining the mapping comprises:
determining the number of contiguously allocated resource blocks based on the indicated length and a value of the determined distribution configuration.

19. The method of claim 18, wherein the number of contiguously allocated resource blocks is determined as L_{RBs}=F·L_{block}, where F denotes the value of the distribution configuration, and L_{block} denotes the length in terms of contiguously allocated resources indicated by the received resource allocation indication.

20. The method of claim 18, wherein determining the mapping comprises:
if the indicated length is less than a value of the determined distribution configuration, determining the number of contiguously allocated resource blocks to be equal to the value of the determined distribution configuration; and
if the indicated length is no less than the value of the determined distribution configuration F, determining the number of contiguously allocated resources to be the indicated length.

21. The method of claim 18, wherein determining the mapping comprises:
determining the number of contiguously allocated resource blocks to be L_{RBs}=m·F, where m is the smallest integer which makes m.F equal to or larger than the indicated length.

22. A method for resource allocation, comprising:
determining a mapping between an allocated virtual resource and a physical resource for a transmission from a terminal device, based on a granularity configuration and a distribution configuration for the terminal device, the granularity configuration indicating a resource granularity for the mapping, and the distribution configuration indicating the number of resource groups into which the allocated virtual resource is divided when being mapped to the physical resource; and
receiving the transmission from the terminal device in the physical resource.

23-46. (canceled)

47. The method of claim 22, further comprising:
transmitting at least one of the granularity configuration and the distribution configuration to the terminal device, or
determining at least one of the granularity configuration and the distribution configuration based on a predefined table associating the at least one of the granularity configuration and the distribution configuration with at least one of a subcarrier spacing, a system bandwidth and the total number of resource blocks in the system bandwidth.

48. The method of claim 22, wherein determining the mapping comprises:
determining the resource granularity for the mapping as a resource element bundle comprising a plurality of subcarriers, based on a value of the granularity configuration and the number of subcarriers in a resource block, or
determining the number of resource groups based on the granularity configuration and distribution configuration, or
determining spacing between adjacent resource groups based on total number of resource blocks in a system bandwidth and the distribution configuration.

49. A terminal device, comprising a processor and a memory, said memory containing instructions executable by said processor whereby said terminal device is operative to perform a method according to claim 1.
